(19) United States
(12) Patent Application Publication
(10) Pub. No.: US 2023/0147045 A1
(43) Pub. Date: May 11, 2023

(54) Solar Powered Airships

(71) Applicant: John Galaz, Los Lunas, NM (US)

(72) Inventor: John Galaz, Los Lunas, NM (US)

(21) Appl. No.: 17/958,722

(22) Filed: Oct. 3, 2022

Related U.S. Application Data
(63) Continuation-in-part of application No. 17/731,307, filed on Apr. 28, 2022.
(60) Provisional application No. 63/193,684, filed on May 27, 2021.
(60) Provisional application No. 63/183,793, filed on May 4, 2021.

(51) Int. Cl. B64B 1/30; B64C 39/04; B64D 27/24; B64D 27/10; B60L 8/00; B64C 1/26; B64B 1/20; B64B 1/22; B64D 47/08; B64B 1/14; F02B 61/04; H01M 10/46

(52) U.S. Cl. CPC B64B 1/30; B64C 39/04; B64D 27/24; B64D 27/10; B60L 8/003; B64C 1/26; B64B 1/20; B64B 1/22; B64D 47/08; B64B 1/14; F02B 61/04; H01M 10/465; B64D 2211/00; B64D 2027/026

(57) ABSTRACT

A solar powered airship includes a cabin, at least one fuselage having an interior volume filled with a volume of a lighter-than-air gas such as helium, and a wing affixed to the fuselage. A plurality of solar panels are affixed to the wing and to the fuselage. A plurality of rotors are affixed to the wing, wherein each rotor is powered via an electric motor having a battery that is operably connected to the plurality of solar panels, thereby allowing for continuous flight. The solar powered airship may further include propellors, which may also be powered via the solar panels, or which may include gasoline powered motors. The solar powered airship can include various configurations and numbers of fuselages, wings, rotors, and propellors.

### CROSS REFERENCE TO RELATED APPLICATIONS

This application claims the benefit of U.S. Provisional Application No. 63/183,793 filed on May 4, 2021, and of U.S. Provisional Application No. 63/193,684 filed on May 27, 2021. The above identified patent applications are herein incorporated by reference in their entirety to provide continuity of disclosure.

### BACKGROUND OF THE INVENTION

The present invention relates to solar powered airships. More specifically, the present invention provides a solar powered airship having many configurations, wherein the solar powered airship utilizes solar energy for power and obtains lift in multiple ways: by the aerodynamics of the aircraft, by water vapor, by lighter than air gas, and by rotors powered via electric motors.

Different types of aircraft include different mechanisms for generating lift and propulsion. Most aircraft include only a single primary mechanism for generating lift. For example, a helicopter relies on rotor blades, an airplane relies on wing shape, and a hot air balloon relies on lighter-than-air gases. Relying on a single means of lift reduces the overall effectiveness of the aircraft, as some means of generating lift do not work in certain situations. For example, an airplane wing will only generate lift if the airplane is propelled forward. Further, many aircraft in existence today are powered by burning carbon emitting fuel types, which has a negative impact on the environment. In order to address these concerns, it is desired to provide an aircraft that can be powered via renewable energy such as a solar energy, and that includes multiple mechanisms for generating lift and propulsion.

Hydrogen gas is a common element that can be utilized for generating lift, but it can be dangerous in transport applications due to its extreme flammability. Helium is a safer gas to use, but is less common and much more expensive for that reason. To address these concerns, one embodiment of the present invention utilizes water vapor as a means for generating lift. In order to produce water vapor, a microwave device heats water stored in a reservoir as it is pumped through multiple misters. The microwave device output can be controlled and adjusted by the aircraft operator to control the altitude and other conditions of the aircraft in flight. Helium and other safer lighter than air gases can be utilized in lieu of or in addition to the water vapor.

In light of the devices disclosed in the known art, it is submitted that the present invention substantially diverges in design elements from the known art and consequently it is clear that there is a need in the art for an improvement to existing aircraft-type devices, particularly due to the lack of renewable energy power sources and the lack of multiple lift mechanisms. In this regard the present invention substantially fulfills these needs.

### SUMMARY OF THE INVENTION

In view of the foregoing disadvantages inherent in the known types of static support devices now present in the prior art, the present invention provides a solar powered airship wherein the same can be utilized to provide an improved aircraft that is more fuel efficient and has less of a negative impact on the environment, which also has multiple mechanisms for providing thrust and lift.

In general, solar powered airship includes a cabin, which can be a cargo hold, a cockpit, an external sensor device, or some combination thereof. The solar powered airship includes at least one fuselage having an interior volume filled with a volume of a lighter-than-air gas. Some embodiments can include multiple fuselages, and the fuselages can include different shapes. A wing is affixed to the fuselage, which may be a straight wing extending between multiple fuselages or an annular wing that encircles a circular fuselage. A plurality of solar panels affixed to the wing and to the fuselage. The solar panels are operably connected to one or more batteries for storing the collected solar energy as usable electricity. A plurality of rotors are affixed to the wing. Each rotor is powered via an electric motor with at least one battery that is operably connected to the plurality of solar panels. The solar powered airship can also include propellors for thrust. In this way, the solar powered airship can operate continuously as desired, and without the need for burning fossil fuels which harm the environment.

One object of the present invention is to provide a solar powered airship can include various configurations and numbers of fuselages, wings, rotors, and propellors, depending upon the desired use of the airship.

Another object of the present invention is to provide a solar powered airship that includes additional gasoline motors as supplemental sources of energy if needed.

Other objects, features, and advantages of the present invention will become apparent given the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of one embodiment of the solar powered airship.

FIG. 2 shows a side elevation view of a second embodiment of the solar powered airship.

FIG. 3 shows an underside perspective view of the second embodiment of the solar powered airship.

FIG. 4 shows an underside perspective view of a third embodiment of the solar powered airship.

FIG. 5 shows a side elevation view of a fourth embodiment of the solar powered airship.

FIG. 6 shows a side elevation view of a fifth embodiment of the solar powered airship.

### DETAILED DESCRIPTION OF THE INVENTION

Reference is made herein to the attached figures. For the purposes of presenting a brief and clear description of the present invention, the preferred embodiment will be discussed as used for providing a solar powered airship that is powered via renewable solar energy. The figures are intended for representative purposes only and should not be considered to be limiting in any respect.

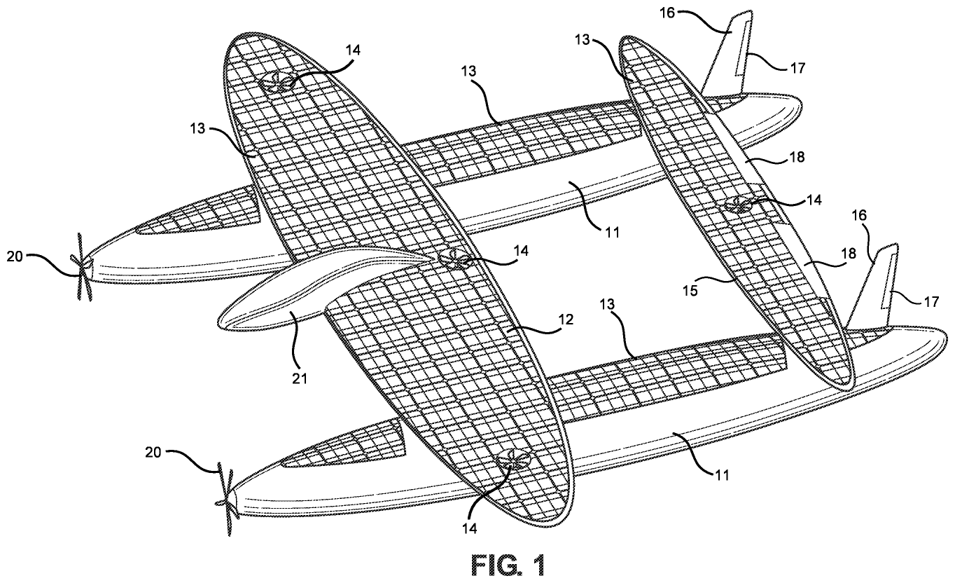

Referring now to FIG. 1, there is shown a perspective view of one embodiment of the solar powered airship. The solar powered airship includes a cabin 21, which can have many different embodiments. The cabin 21 can be a cockpit, a cargo storage, a passenger compartment, or some combination thereof. As will be discussed, the cabin 21 can be replaced with drone modules such as sensors, cameras, and the like. In the shown embodiment, the cabin 21 is affixed to a central portion of a front wing 12 to provide optimal visibility for the operator. The solar powered airship further includes at least one fuselage 11 having an interior volume filled with a volume of a lighter-than-air gas. In one embodiment, the fuselage 11 is filled with helium. In another embodiment, or to supplement the helium, the fuselage 11 is filled with water vapor. The water vapor can be generated via a microwave device which heats water stored in a reservoir as it is pumped through multiple misters. The microwave device output can be controlled and adjusted by the airship operator to control the altitude and other conditions of the airship in flight. In other embodiments, various valves and the like can be controlled via the operator to control the amount and flow of helium or other lighter than air gases.

The solar powered airship is shown here with a pair of parallel-oriented fuselages 11. In other embodiments, there can be more than two fuselages 11, or just a single fuselage 11. At least one wing 12 is affixed to the fuselage 11. The wing 12 can provide lift forces to elevate the solar powered airship while under thrust. For example, a propellor 20 may be affixed to the front ends of each fuselage 11 for providing thrust. The propellors 20 may be powered via electrical motors, or gasoline powered motors in some embodiments. In the shown embodiment, the wing 12 extends across the pair of fuselages 12 and further outwardly to provide a large area for generating lift.

The shown embodiment further includes a tail 15 that extends across the rear ends of the fuselages 11. The tail 15 can include a pair of elevators 16 along its rear edge to control the pitch of the solar powered airship. The tail 15 can also extend outwardly to provide an additional wing for additional lift. Further, the shown embodiment also includes a vertical stabilizer 16 affixed to the rear portion of each fuselage 11. The vertical stabilizers 16 include a rudder 17 which is utilized to control the yaw of the solar powered airship. In some embodiments, the wing 12 can also include ailerons which can be utilized to control the roll of the solar powered airship.

A plurality of solar panels 13 are affixed to the wing 12 and to the fuselages 11. The solar panels 13 are positioned in such a way to have maximum exposure to the sun. The solar panels 13 are operably connected to a network of batteries, which are configured to collected solar energy into stored electrical energy. This stored electrical energy is then utilized to power the various systems of the solar powered airship. A plurality of rotors 14 are affixed to the wing 12, which generate lift and assist with takeoff and landing. In the shown embodiment, rotors 14 are also affixed to the tail 15 for generating greater lift forces. Each rotor 14 is powered via an electric motor having a battery that is operably connected to the plurality of solar panels 13.

The propellors 20 may also be powered via an electric motor having a battery that is operably connected to the plurality of solar panels 13. The propellors 20 can also include gasoline powered internal combustion engines that provide an assistive means for powering the airship in the event that solar energy is not available, and the batteries are depleted. In the shown embodiment, the tail 15 also includes a plurality of solar panels 13. Maximizing the surface area of the solar panels 13 allows for more solar energy to be collected and stored, furthering the goal of making the solar powered airship operational for long continuous time periods.

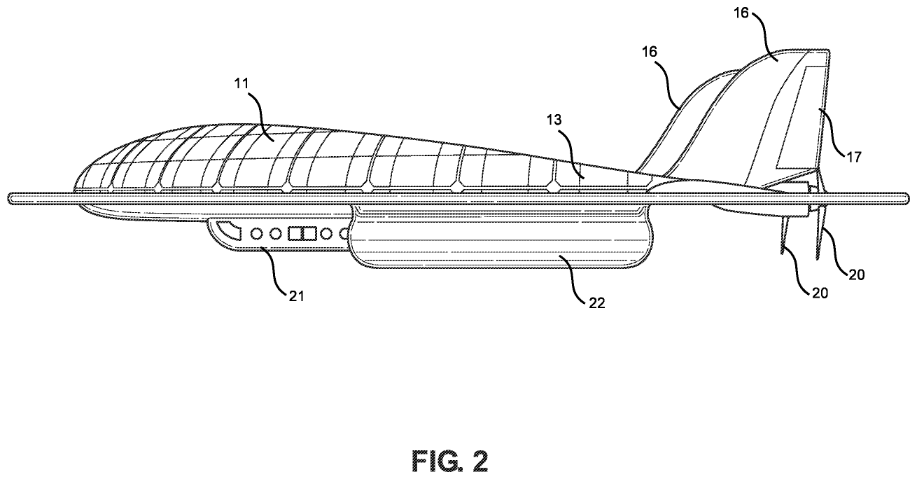

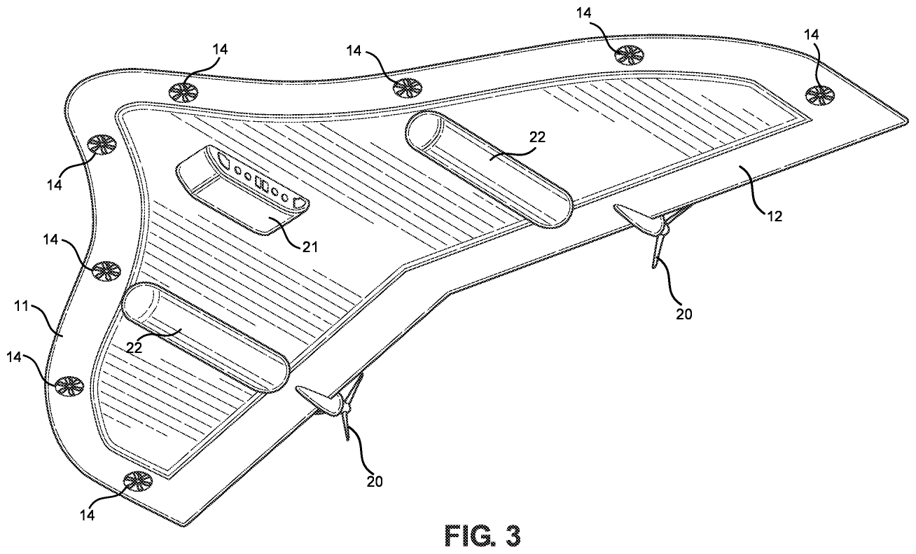

Referring now to FIGS. 2 and 3, there are shown elevation and perspective views of a second embodiment of the solar powered airship. In this embodiment, the wing 12 is a fixed wing that surrounds the fuselage 11. The cabin 21 is affixed to an underside of the fuselage 11. Canisters 22 are affixed to an underside of the fuselage 11, wherein the canisters 22 include an interior filled with a volume of lighter-than-air material. The canisters may be in fluid communication with the interior volume of the fuselage 11, in order to transfer lighter than air gas from the canisters 22 to the fuselage 11 as needed. In this embodiment, the propellors 20 are affixed to the rear wing for generating horizontal thrust, while the rotors 14 are disposed around the perimeter of the fixed wing 12 for generating vertical thrust.

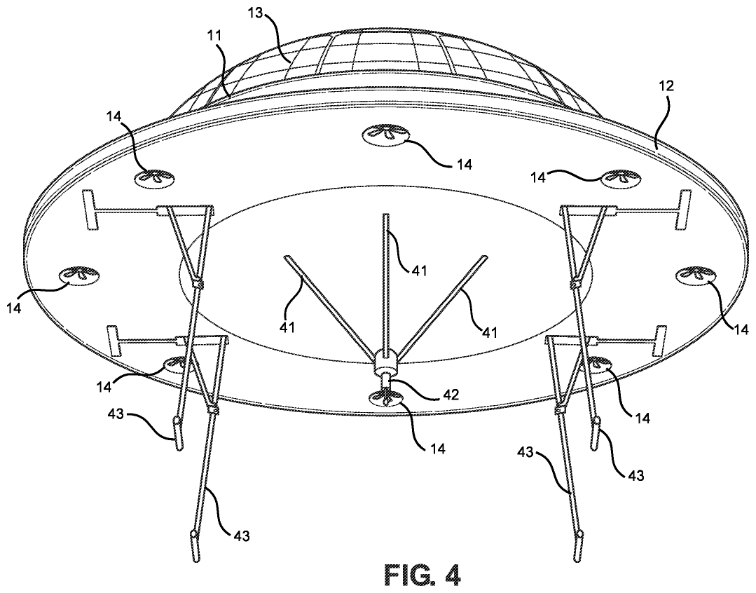

Referring now to FIG. 4, there is shown an underside perspective view of a third embodiment of the solar powered airship. The solar powered airship can also be embodied as an unmanned aerial vehicle, commonly referred to as a drone. In such embodiments, the wing 12 is circular and surrounds a central fuselage 11. The rotors 14 disposed around the wing 12 are configured to provide both vertical and horizontal thrust via adjustment from the operator. The solar panels 13 are affixed to both the upper surfaces of the wing 12 and the fuselage 11.

A communications antenna 42 is affixed to the underside of the fuselage 11, such that it does not block the solar panels 13 from receiving sunlight. The communications antenna 42 allows for wireless control of the solar powered airship, and can also provide a mechanism that facilitates communications between remote locations. In the shown embodiment, the communications antenna 42 is connected to the fuselage 11 via multiple connecting rods 41. This embodiment can include additional sensors and other devices depending upon the desired use of the solar powered airship. Further, the shown embodiment includes supporting legs 43 that support the fuselage 11 in an elevated position above the ground, so as not to damage the communications antenna 42 and other components during landing. In some embodiments, the supporting legs 43 can be adjustable between a retracted position during flight and a deployed position during landing.

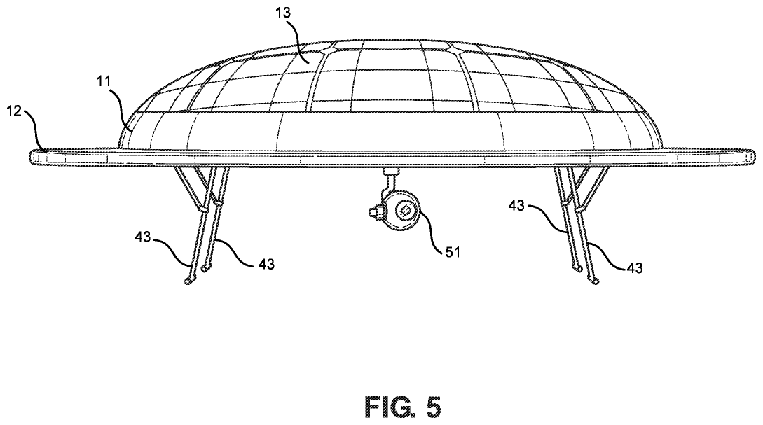

Referring now to FIG. 5, there is shown a side elevation view of a fourth embodiment of the solar powered airship. In the shown embodiment, the airship includes a camera system 51 affixed to an underside of the fuselage 11. The camera system 51 can wirelessly transmit images to a remote location, and can include additional sensor systems if desired. The positioning of the camera system 51 can also be controlled remotely by the operator.

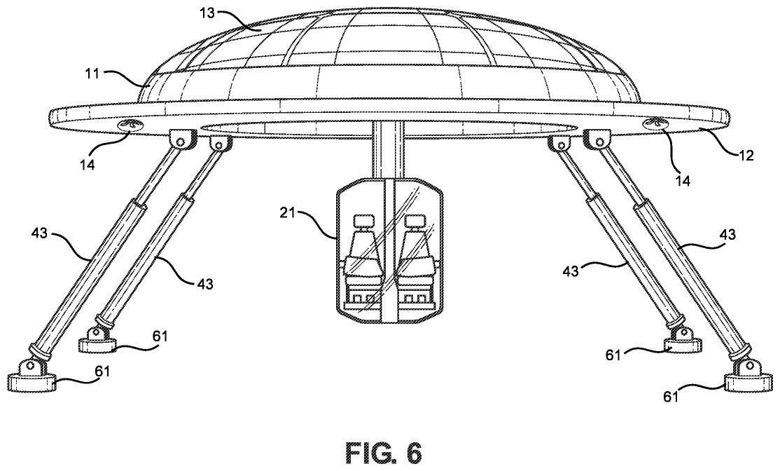

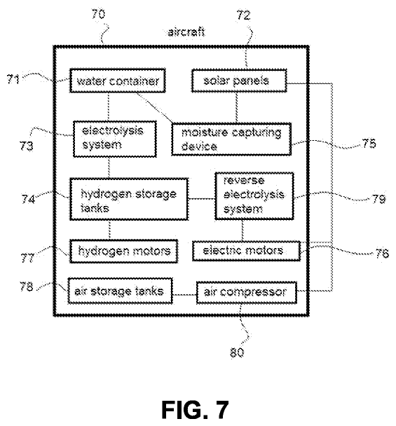

Referring now to FIG. 6, there is shown a side elevation view of a fifth embodiment of the solar powered airship. In the shown embodiment, the cabin 21 extends downwardly from the fuselage 11. The support legs 43 are telescopically adjustable and may include impact absorbing shocks. Further, the support legs 43 in the shown embodiment include pivotally adjustable feet 61, which provide for smoother takeoff and landing capabilities. As with the embodiments shown in FIGS. 4 and 5, the rotors 14 are disposed on the wing 12 surrounding the fuselage 11, and are powered via the solar panels 13.

Referring now to FIG. 7, there is shown a diagram of a sixth embodiment of the solar powered airship. In this embodiment, a container of water 71 is located within a portion of the aircraft 70. The water can be added to the container manually. In other embodiments, there is a moisture capturing device 75 that is capable of converting water vapor in the air through which the aircraft flies into liquid water for storage in the container 71. In addition to powering electric motors 76, the solar panels 72 are configured to convert the water within the container 71 into oxygen and hydrogen via an electrolysis system 73. The resulting hydrogen is routed to interior storage tanks 74 that can be within the wing or fuselage of the aircraft 70. During daytime, solar panels 72 produce electricity for the electric motors 76 that power the aircraft 70 as well as the hydrogen. During nighttime, the hydrogen can be converted back to water via a reverse electrolysis type system 79 which generates electricity during the process, or it can be fed to different motors 77 which utilize hydrogen as a fuel source. In this way, the aircraft can fly continuously and will not be limited to operating in daytime hours. It also eliminates the need for heavy batteries, which would increase the energy needs of the aircraft. The result is an aircraft that is lighter than one with batteries, needs less energy to operate, and can be made smaller than an aircraft with batteries as the sole means of storing electricity.

In the shown embodiment, there may also be the use of an air compressor 80 in the aircraft 70, to be used as an air bladder, which provides additional control over lift. Upon lift off, lighter than air gas, is pumped into sacks inside the wings and fuselage, expanding the sacks and causing the aircraft to rise. To land, the gas is pumped out of the wings and fuselage and compressed into a tank 78. This will allow the aircraft to use less energy, as the lighter than air gas will be providing most of the lift, and upon landing, the gas is compressed resulting in a heavier aircraft that won't fly away when it is unloaded.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A solar powered airship comprising:
a cabin;
at least one fuselage having an interior volume filled with a volume of a lighter-than-air gas;
a wing affixed to the fuselage;
a plurality of solar panels affixed to the wing and to the fuselage;
a plurality of rotors affixed to the wing, wherein each rotor is powered via an electric motor having a battery that is operably connected to the plurality of solar panels.

2) The solar powered airship of claim 1, wherein the at least one fuselage comprises a pair of fuselages, and further comprising a tail extending between a rear portion of each fuselage.

3) The solar powered airship of claim 2, further comprising a propellor affixed to a front end of each fuselage.

4) The solar powered airship of claim 3, wherein each propellor is powered via an electric motor having a battery that is operably connected to the plurality of solar panels.

5) The solar powered airship of claim 3, wherein each propellor is powered via an internal combustion engine.

6) The solar powered airship of claim 2, wherein the tail comprises a pair of elevators disposed along a rear edge thereof.

7) The solar powered airship of claim 2, further comprising a vertical stabilizer affixed to the rear portion of each fuselage, wherein each vertical stabilizer comprises a rudder.

8) The solar powered airship of claim 2, wherein the cabin is affixed to a central front portion of the wing.

9) The solar powered airship of claim 2, further comprising a plurality of solar panels affixed to the tail.

10) The solar powered airship of claim 9, further comprising at least one rotor affixed to the tail, wherein each rotor is powered via an electric motor that is operably connected to the plurality of solar panels that are affixed to the tail.

11) The solar powered airship of claim 1, wherein the cabin is affixed to an underside of the fuselage.

12) The solar powered airship of claim 1, further comprising at least one canister affixed to an underside of the fuselage, the at least one canister comprising an interior filled with a volume of lighter-than-air material, wherein the at least one canister is in fluid communication with the interior volume of the at least one fuselage.

13) The solar powered airship of claim 1, further comprising at least one propellor affixed to a rear edge of the wing.

14) The solar powered airship of claim 1, further comprising a communications antenna affixed to an underside of the at least one fuselage.

15) The solar powered airship of claim 1, further comprising a camera affixed to an underside of the at least one fuselage.

16) The solar powered airship of claim 1, further comprising a plurality of support legs affixed to an underside of the at least one fuselage.

17) The solar powered airship of claim 16, further comprising a pivotally adjustable foot affixed to each support leg of the plurality of support legs.

18) The solar powered airship of claim 1, further comprising a water tank operably connected to an electrolysis mechanism that is configured to convert the water into oxygen and hydrogen and store the hydrogen in one or more storage tanks.

19) The solar powered airship of claim 1, further comprising an air compressor configured to compress a volume of lighter than air gas which is stored within the fuselage when expanded.
